(19) United States
(12) Patent Application Publication
(10) Pub. No.: US 2025/0254534 A1
(43) Pub. Date: Aug. 7, 2025

(54) TROPOSPHERIC DUCTING DETECTION AND MITIGATION SYSTEM

(71) Applicant: T-MOBILE INNOVATIONS LLC, Overland Park, KS (US)

(72) Inventors: Khaled Mohamed OMAIRA, Glen Ellyn, IL (US); Farzad ERFANI, Lake Forest, IL (US)

(21) Appl. No.: 18/434,407

(22) Filed: Feb. 6, 2024

(51) Int. Cl. H04W 24/02; H04B 17/309; H04B 17/345

(52) U.S. Cl. CPC H04W 24/02; H04B 17/345; H04B 17/346

(57) ABSTRACT

Embodiments of the present disclosure are directed to systems and methods for mitigating atmospheric ducting within a wireless telecommunication network. The methods include monitoring uplink frequency segments to establish a noise plus interference (N+I) baseline, comparing the average interference of initial uplink symbols against this baseline, and detecting a predetermined threshold of interference. Upon exceeding this threshold, the method entails a comprehensive monitoring of all uplink symbols to identify a downhill shape pattern indicative of ducting interference. Responsive to this detection, the system dynamically implements one or more mitigation techniques.

### SUMMARY

The present disclosure is directed to improving the mitigation of the effects of tropospheric ducting within a telecommunication network, substantially as shown and/or described in connection with at least one of the Figures, and as set forth more completely in the claims.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 depicts a network environment in which implementations of the present disclosure may be employed, in accordance with aspects herein;

FIG. 3 depicts a diagram of tropospheric ducting occurring in a network environment;

FIG. 4 depicts a diagram of a method for mitigating tropospheric ducting interference in a wireless telecommunication network in accordance with aspects herein;

FIG. 5 depicts a flow diagram of a method for mitigating tropospheric ducting interference in a wireless telecommunication network in accordance with aspects herein;

FIG. 6 depicts a flow diagram of a second method for mitigating tropospheric ducting interference in a wireless telecommunication network in accordance with aspects herein; and

FIG. 7 depicts a flow diagram of a second method for mitigating tropospheric ducting interference in a wireless telecommunication network in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to network access technology for the provision of wireless telecommunication services from a base station to one or more electronic devices, such as an eNodeB, gNodeB, etc. The term “cell” is used to describe one or more hardware and software components of a base station that are configured to provide wireless communication service to a geographic area.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, time of flight (TOF) interference is a situation where radio frequency signals from a wireless communication network are received much farther from the transmitter than desired. In some cases, signals intended to cover distances of 10 miles or less can travel much further. They may extend dozens or even hundreds of mile. This is often caused by tropospheric ducting, a meteorological phenomenon where layers of warm and cold air form at different altitudes. If warm air is sandwiched between two cold layers, it creates a duct that traps radio frequency signals, making them travel farther than usual. This can lead to interference and degrade the user experience.

Conventionally, systems and methods to address radio frequency signal interference from tropospheric ducting involve forecasting potential events and optimizing network configurations to minimize interference. This often includes physical adjustments such as base station antenna tilting to reduce the chance of intercepting interfering frequencies from distant stations, as well as transmission power adjustments aimed at maintaining a stable link. However, these methods are limited by the existing capabilities of the wireless network infrastructure and are only partially effective due to the inherent unpredictability of tropospheric ducting, which is highly dependent on fluctuating weather conditions and atmospheric temperature profiles.

Compounding this issue is the challenge of accurately identifying the noise floor within the affected frequency bands. Traditional approaches may not adequately distinguish between the normal ambient noise level and the increased interference caused by tropospheric ducting, leading to a reactive rather than proactive network response. Without a precise identification of the noise floor, mitigation efforts such as reconfiguring antenna parameters or altering signal characteristics can be slow and imprecise, potentially resulting in further network inefficiencies. These adjustments, while well-intentioned, fail to address the dynamic nature of atmospheric ducting and its impact on signal propagation, necessitating more sophisticated and responsive interference management techniques.

Unlike conventional solutions, this disclosure introduces techniques for detecting and mitigating atmospheric ducting phenomena within a telecommunications network. Initially, the system monitors the last set of symbols of a second uplink time slot, evaluating them over a monitoring period to establish a noise plus interference (N+I) baseline for the uplink frequency segments. Subsequently, the system monitors the first and second uplink symbols of a first uplink time slot immediately following a guard period. These symbols are compared against the established N+I baseline to assess if interference levels are exceeding normal operational parameters. If a significant deviation is detected, the system expands its monitoring to encompass all uplink symbols, searching for a downhill shape pattern in the uplink symbols. This pattern is indicative of interference caused by tropospheric ducting. Upon detection of such a pattern, the system proceeds with one or more mitigation techniques. Among those mitigation techniques described herein is the dynamic reallocation of the random access channel (RACH).

Accordingly, a first aspect of the present disclosure introduces a non-transitory computer readable media with instructions that, when executed by one or more computer processing components, facilitate the mitigation of atmospheric ducting within a telecommunications network. The instructions involve detecting, by a network management system, a condition of tropospheric ducting affecting signal propagation within a predefined frequency band. They further include identifying segments within this band where a RACH is operational and dynamically reallocating the RACH from the affected segments to others less affected by the ducting, based on real-time network data.

A second aspect of the present disclosure pertains to a system designed to enhance the provision of notifications within a wireless telecommunication network. This system includes a victim base station that communicates wirelessly with user equipment (UE). The system is equipped with one or more computer processing components that perform operations such as monitoring the last set of symbols of a second uplink time slot to establish an N+I baseline for uplink frequency segments. It compares the average interference of the first uplink symbols with this baseline and, upon detecting excessive interference, initiates monitoring of all uplink symbols to detect a downhill shape pattern indicative of interference caused by tropospheric ducting, ultimately triggering a set of predefined mitigation techniques.

Another aspect of this disclosure relates to a method for mitigating tropospheric ducting in a wireless telecommunication network. The method includes monitoring interference levels across multiple uplink symbols cross entire bandwidth and identifying PRBs that exceed a predetermined threshold of interference. Following the identification, the method dynamically blanks these PRBs by ceasing transmission to reduce or eliminate interference. It then reallocates the uplink and downlink transmissions originally assigned to the blanked PRBs to alternative PRBs less affected by tropospheric ducting.

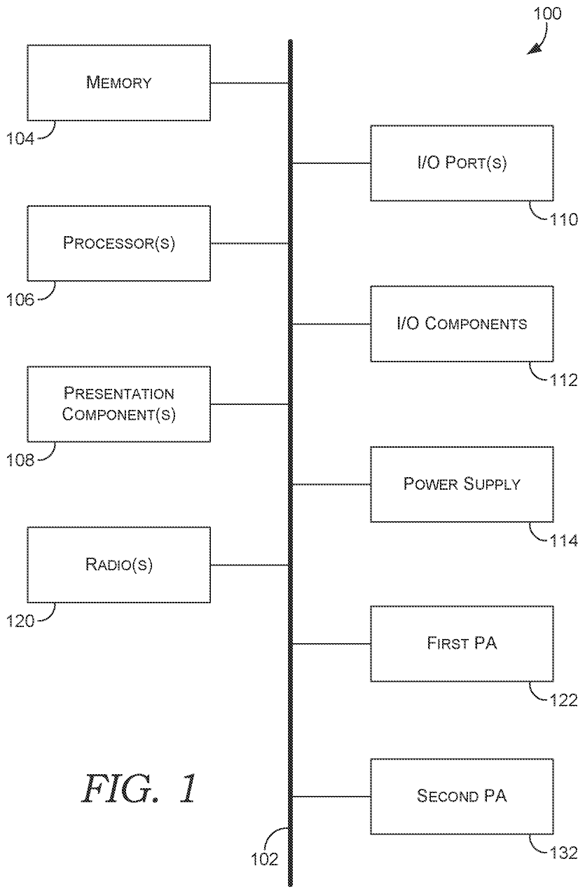

Turning now to FIG. 1, which depicts computing device 100 that typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g., a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VOLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

As used herein the term “LTE” refers to the 4G Long-Term Evolution standard for cellular network. Additionally, as used herein the term “5G” refers to the 5G is the fifth-generation technology standard for cellular networks. Both LTE and 5G enable communications between a network and a user device, where an air interface is the radio frequency portion of the circuit between the user device and the network. Both LTE and 5G can be deployed using frequency division duplexing (FDD) or time division duplexing (TDD) technology. In FDD technology, up-link and downlink signals are assigned certain frequencies of bandwidth to facilitate communication between the user device and the network. While for TDD, up-link and downlink signals are assigned timeslots for transmission or reception to facilitate communication. In 5G there is a flexibility to assign different bandwidth part to UEs.

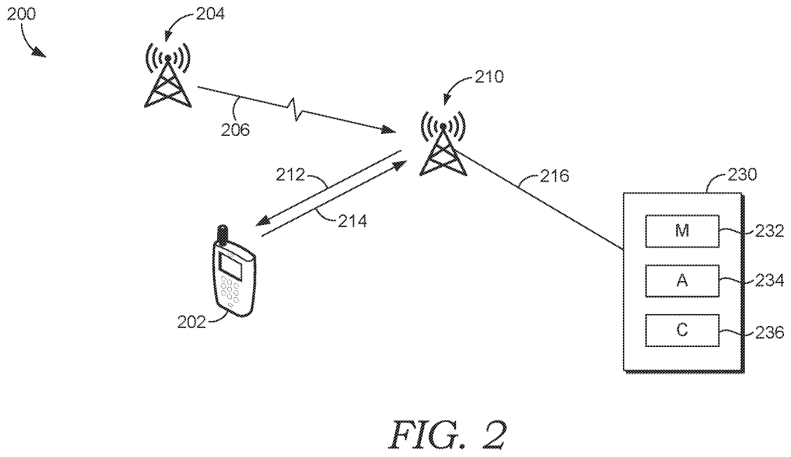

Turning now to FIG. 2, an exemplary network environment is illustrated in which implementations of the present disclosure may be employed. Such a network environment is illustrated and designated generally as network environment 200. At a high level the network environment 200 comprises a UE 202, one or more base stations, and one or more networks. Though the UE 202 is illustrated as a cellular phone, a UE suitable for implementations with the present disclosure may be any computing device having any one or more aspects described with respect to FIG. 1. Similarly, though the one or more base stations are illustrated as macro cells on a cell tower, any scale or form of access point acting as a transceiver station for wirelessly communicating with a UE, including small cells, pico cells, and the like, are suitable for use with the present disclosure. The network environment 200 is but one example of a suitable network environment and is not intended to suggest any limitation as to the scope of use or functionality of the disclosure. Neither should the network environment 200 be interpreted as having any dependency or requirement to any one or combination of components illustrated.

The network environment 200 comprises one or more base stations to which the UE 202 may potentially connect to (also referred to as ‘camping on’, ‘attaching’ in the industry). Though the network environment 200 is illustrated with three distinct base stations, one skilled in the art will appreciate that more or fewer base stations may be present in any particular network environment suitable for use with the present disclosure. The one or more base stations of network environment 200 may comprise one or more of an aggressor base station 204 and a victim base station 210. Each of the one or more base stations of the network environment 200 is configured to wirelessly communicate with UEs, such as the UE 202. In aspects, any of the one or more base stations may communicate with a UE using any wireless telecommunication protocol desired by a network operator, including but not limited to 3G, 4G, 5G, 6G, 802.11x and the like. Relevant to the present disclosure, each of the one or more base stations is associated with a network identifier (e.g., a Public Land Mobile Network (PLMN) number). Each of the one or more base stations may be generally said to be configured to communicate with one or more UEs located within a geographical area. A geographical area for any particular base station may be referred to as the “coverage area” of the base station or simply as a “cell.” In some aspects, each cell is defined by an area in which signaling between a particular UE and the base station is usable for any purpose. Each of the base stations of the network environment 200 may be used to provide coverage to a plurality of cells, wherein one or more of the plurality of cells at least partially overlap; for example, the victim base station 210 may provide coverage to a first cell and a second cell, wherein the first cell and the second cell at least partially overlap. Generally, each base station of the one or more base stations may comprise one or more base transmitter stations, radios, antennas, antenna arrays, power amplifiers, transmitters/receivers, digital signal processors, control electronics, GPS equipment, and the like.

In some aspects, each of the base stations may utilize a plurality of cells, wherein the cells are operating using the same telecommunications protocol. For example, the victim base station 210 may operate multiple cells, all utilizing a single RAT, such as TDD. In other aspects, each of the base stations may utilize a plurality of cells, wherein the cells are operating using a plurality of telecommunication protocols as desired by the network. For example, the victim base station 210 may utilize a first cell providing coverage using a first RAT and a second cell using providing coverage using a second RAT. The coverage of the first cell and the second cell may be substantially similar in coverage area and overlap. The first and second cells may be located on the same transmitter station (“tower”) or may be geographically separated but controlled by the victim base station 210. For example, the victim base station 210 may have the first or primary cell, which operates using TDD and the second, or secondary cell, which operates using FDD. The aggressor base station 204 and the victim base station 210 may operate using at least one of the same telecommunication protocols, such as TDD.

Each base station of the network environment 200 is configured to transmit downlink signals to one or more UEs, such as the UE 202 and to receive uplink signals therefrom. For the purposes of network environment 200, the victim base station 210 transmits downlink signals on a first downlink 212. The victim base station 210 receives uplink signals on a first uplink signal 214. The aggressor base station 204 transmits downlink signals on a third downlink 206 that reaches victim base station 210 and interfere with Uplink signal form UE 202 that tries to communicate with victim base station.

Network environment 200 includes user equipment (UE) 202 configured to wirelessly communicate with the one or more base stations of the network environment 200. The UE 202 may take on a variety of forms, such as a personal computer (PC), a user device, a smart phone, a smart watch, an extended reality (XR) device, Internet of Things (IoT) device, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device that comprising any one or more feature of computing device 100 of FIG. 1.

The network environment 200 additionally comprises one or more hardware and/or software components that, together, make up a TOF mitigation engine 230. The TOF mitigation engine 230 may be said to comprise a monitor 232, an analyzer 234, and a controller 236. The monitor 232 is generally configured to determine that TOF interference is taking place and affecting the ability of the UE 202 to utilize the victim base station 210. Specifically, the UE 202 may be having trouble communicating with one or more of a victim cell on the victim base station 210.

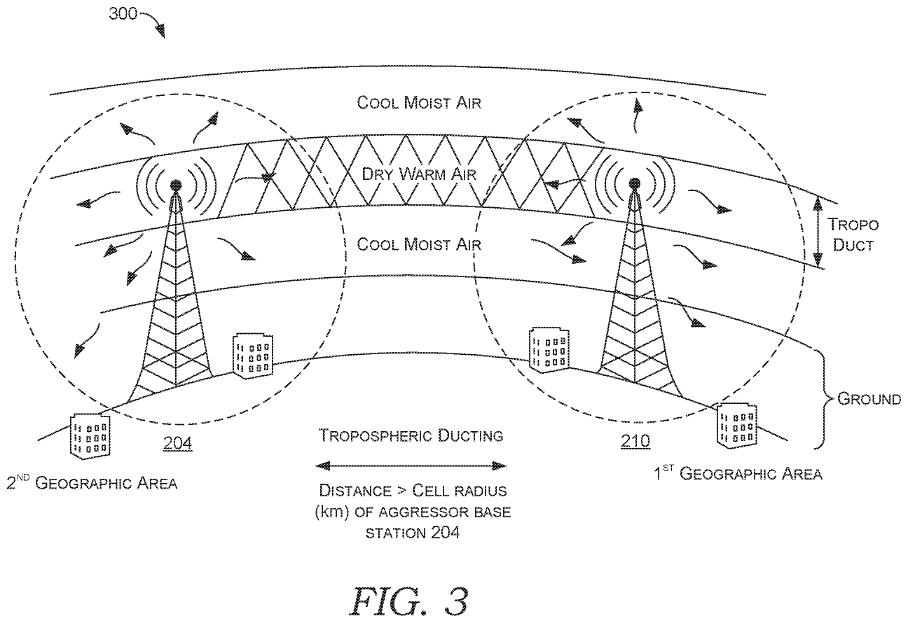

The monitor 232 is generally configured to determine that TOF interference is taking place in a first geographic region, in which the UE 202 is located. Any suitable means for determining the existence of TOF interference would be suitable for use with the present disclosure, including the use of tropospheric ducting forecasts, observations of the third downlink 206 comprising a cell identifier of the aggressor base station 204 (combined with a determination that the aggressor base station 204 is located greater than a predetermined threshold distance from the victim base station 210), or by determining that a signal parameter is sufficiently different at a first portion of an uplink time period (e.g., an uplink subframe) when compared to a second, later, portion of the uplink time period. An illustration of tropospheric ducting is presented in FIG. 3. As illustrated, in network environment 300, the aggressor base station 204 from FIG. 2, located in a second geographic region, may broadcast radio frequency signals, which become trapped in a layer or duct of dry, warm air positioned in between layers of cool, moist air. These radio frequency signals travel a greater distance than intended, beyond the cell radius of the aggressor base station 204, to the victim base station 210, located in the first geographic region. When signals from the aggressor base station 204 are of sufficiently proximate frequencies, they can cause interference at the victim base station 210, particularly when the downlink signals from the aggressor base station 204 arrive during an uplink time period of the victim base station 210. That is, as the victim base station 210 may realize noise from the downlink signals of the aggressor base station 204 when the victim base station 210 is scheduled to be receiving uplink signals from a UE.

Returning to FIG. 2, in one embodiment, the monitor 232 can be configured to continuously monitor the last set of symbols within a second uplink time slot over a designated monitoring time period. Wherein the last set of symbols can be the last 1, the last 4, the last 7, or any number of the last set of symbols of the second uplink time slot. During this period, the monitor 232 establishes a baseline threshold derived from these symbols' average interference measurements, which will serve as a comparative metric for subsequent signal evaluations.

Subsequent to establishing this baseline, the monitor 232 proceeds to monitor the average interference present in the first and second uplink symbols after a guard period. Should the average interference in these initial symbols exceed the baseline threshold by a predetermined amount, it triggers the monitor 232 to extend its scrutiny across all symbols spanning the first and second uplink time slots. Upon the expansion of the monitoring scope, the analyzer 234 is used to evaluate all of the symbol data collected. The analyzer 234 applies trend detection algorithms to detect any descending trends in signal quality across the uplink time slots. The downward trend analysis by the analyzer 234 correlates the symbol-by-symbol interference levels to identify any consistent decline, which would be symptomatic of progressive signal degradation. Such a downhill trend is indicative of the TOF interference that can disrupt the network's uplink efficiency. If the downhill trend is determined to exceed a threshold, then TOF interference is determined to be occurring or affecting the victim base station 210 enough to enact mitigation techniques.

In some embodiments, the system may implement a monitoring schedule where the last four to seven symbols of the second uplink time slot and the first two symbols are analyzed for five minutes, with this monitoring sequence repeated every six hours. This regimented monitoring schedule allows for the construction of a detailed and accurate interference profile for each frequency segment, ensuring that any deviations from established signal quality benchmarks are promptly detected and assessed.

In the event that a downhill trend is confirmed, the analyzer 234 indicates that TOF interference is occurring and prompts the activation of predefined mitigation protocols. The network then initiates interference mitigation techniques tailored to address and rectify the identified signal impairments. These techniques are customized based on the specific characteristics of the interference and the affected frequency segments, as well as the operational parameters of the gNB or self-organized network (SON).

Once TOF interference is detected to exceed the predetermined threshold by the analyzer 234 it communicates with the controller 236 to initiate one or more mitigation techniques. In a first example, the controller deploys remote interference management reference signal (3GPP RIM-RS) transmissions within the impacted frequency segment. The controller 236 instructs the victim base station 210 to emit RIM-RS, which are signals designed to assess and manage interference levels across the network. These signals provide a granular view of interference, allowing precise adjustments to be made to network parameters. For 3GPP RIM-RS transmission, the victim base station 210 is configured to transmit and then measure reference signals, which are then analyzed to ascertain the interference levels.

In an additional embodiment, the controller 236 engages the SON's predefined algorithm, which has been tailored to the network's specifications. This algorithm autonomously adjusts network configurations, such as power levels and cell breathing, to alleviate the effects of TOF interference. The SON system dynamically orchestrates these adjustments in real-time, based on continuous feedback from network performance metrics. The SON pre-defined algorithm is enacted through a SON management system, which automatically adjusts network parameters according to the real-time analytics of network performance and interference data.

In another embodiment, the controller 236 implements UL physical resource block (PRB) blanking on the victim cell. This process involves selectively deactivating certain PRBs in the uplink frequency spectrum where excessive interference is detected. By ‘blanking’ these PRBs, the network reduces the noise floor, thereby enhancing the signal quality of the remaining active PRBs. The UL PRB Blanking technique is administered by instructing the victim base station 210 to cease transmission on the identified PRBs, thus effectively silencing the noise on these channels. The analyzer can identify PRBs that are effected by the TOF interference and which PRBs are not as effected by the TOF interference. The controller 236 facilitates this by sending configuration updates to the base station, which then enforces the blanking on the designated PRBs that are effected by the TOF interference. PRB scheduling coordination is managed through the base station's scheduling algorithm, which is updated to ensure that PRB assignments are strategically orchestrated to circumvent interference, taking into account the timing and frequency domains of the transmissions.

In another embodiment, the mitigation technique used is PRB scheduling coordination, executed by the controller 236 to prevent RI (Radio Interference) between neighboring cells. This entails adjusting the scheduling of PRBs so that simultaneous transmissions that could result in interference are staggered or shifted to different time slots or frequency resources, effectively minimizing the potential for cross-cell interference.

Lastly, the controller 236 may reallocate the RACH within the frequency domain. If the RACH is identified within an interference-impacted segment, it is dynamically moved to a cleaner segment, based on the interference landscape. The process begins with the identification of the RACH within segments of the frequency spectrum that are adversely impacted by interference. Utilizing a combination of real-time signal analysis and historical interference data, the network management system, inclusive of the analyzer 234 and controller 236, determines the interference levels across the frequency band. The RACH is specifically flagged for reallocation if it resides in a segment where the interference metrics exceed predefined thresholds that suggest a degradation in the quality of access.

To identify a cleaner segment for the RACH reallocation, the controller 236 examines the spectrum for areas with lower interference levels. This involves assessing signal-to-noise ratios, error rates, and other relevant signal quality indicators that reflect a segment's suitability for hosting the RACH. The selection criteria for cleaner segments are based on a set of network policies that prioritize segments with minimal noise and interference, ensuring that the RACH is moved to a part of the spectrum conducive to reliable access attempts by user equipment (UE).

Once a cleaner segment is identified, the analyzer 234 communicates this information to the controller 236, which then orchestrates the reallocation of the RACH. This dynamic reallocation is executed seamlessly to minimize disruption to the network service. The controller 236 manages the reassignment of RACH resources, updating the network configuration and signaling the UE to utilize the newly allocated RACH in the cleaner segment. By doing so, the system ensures an uninterrupted and quality access experience for users, effectively mitigating the impact of tropospheric ducting on the network's performance.

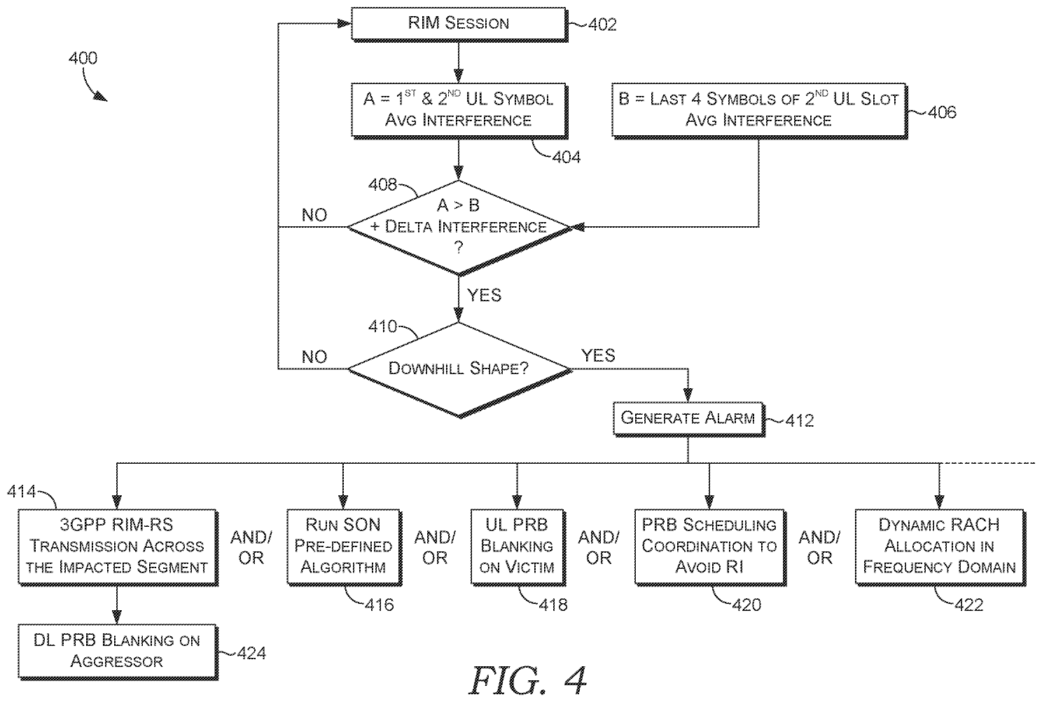

Turning now to FIG. 4, wherein an exemplary flow diagram is that outlines the process for managing uplink interference within a telecommunications network. The flow begins with the initiation of a remote interference management (RIM) session (402). This session is a systematic approach to assessing and mitigating interference in the network. During the RIM session, at step 406, the last four or seven symbols of the second uplink time slot is measured. This establishes a baseline of the network's performance under potential interference conditions. The data collected at this stage is used to determine the integrity of the signal and to assess whether interference is present within the network segment. Simultaneously, at step 404, the system measures the average interference of the first and second uplink symbols. These early symbols are indicative of the initial network conditions and are used for comparison against the baseline established by the last symbols of the second time slot.

Following these measurements, at step 408, the system computes the difference between the average interference of the initial uplink symbols and the baseline interference of the last symbols of the second time slot. If the difference is within an acceptable range, indicating nominal interference, the system will restart a new RIM session at a subsequent measurement time. However, if the difference exceeds a predetermined threshold, suggesting significant interference, the process progresses to the next diagnostic step.

The subsequent step 410 involves a measurement of all symbols across both the first and second time slots. This analysis is designed to detect any patterns in signal degradation, specifically looking for a “downhill trend” that would suggest a consistent decline in signal quality due to environmental factors like tropospheric ducting. If a downhill trend is detected, an alarm is generated at step 412. This alarm acts as a trigger within the network management system, indicating that the interference has reached a level that could impact the network's performance and the quality of service experienced by users.

Upon the triggering of the alarm, the system proceeds to engage various mitigation techniques, such as techniques 414-424. One such technique 414 is the deployment of 3GPP RIM-RS transmissions across the impacted segment. This action involves sending out specific signals designed to evaluate and manage the interference levels, allowing for a targeted response to the conditions observed. In embodiments where a particular cell is identified as an aggressor due to its contribution to interference, DL PRB blanking may be implemented at technique 424. This technique silences the noise by deactivating certain PRBs, reducing the interference footprint of the aggressor cell.

Additionally, the system may run a pre-defined SON algorithm at technique 416. This algorithm autonomously adjusts various network parameters to mitigate interference effects, leveraging real-time analytics and historical data to optimize its response. In a further mitigation technique 418, UL PRB Blanking on the victim cell is used to diminish the impact of interference. By selectively blanking PRBs on the cell experiencing interference, the network can enhance the signal quality of active communications.

Furthermore, at technique 420, PRB scheduling coordination is used to avoid RI between cells. This involves scheduling of PRB transmissions to minimize the potential for cross-cell interference, ensuring a more stable network environment. At technique 422, dynamic RACH allocation in the frequency domain is implemented as a measure to circumvent the interference issues. This process involves dynamically reallocating the RACH to different segments of the frequency spectrum that are identified as being less affected by the interference, thus ensuring reliable access for the user equipment trying to connect to the network.

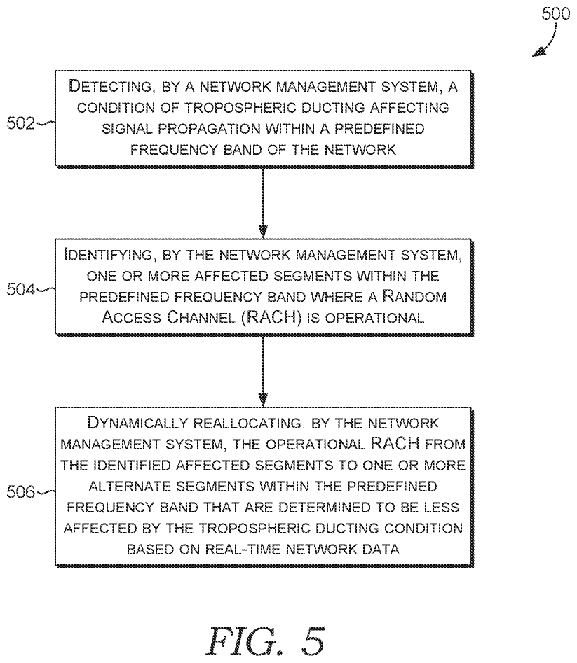

FIG. 5 presents a flow diagram of a method for mitigating tropospheric ducting, as per the described aspects. The method 500 begins at step 502 with the network management system's detection of tropospheric ducting. Once tropospheric ducting is detected, the method progresses to step 504, where the network management system identifies one or more affected segments within the said frequency band. These segments are determined based on their operational status of the RACH, which is used for establishing initial communication between the UE and the network. At step 506, the method entails a dynamic reallocation process, performed by the network management system. This process involves moving the operational RACH from the segments identified as affected by the tropospheric ducting to alternate segments. These alternate segments are selected based on real-time network data, which indicates that they are less affected by the tropospheric ducting conditions.

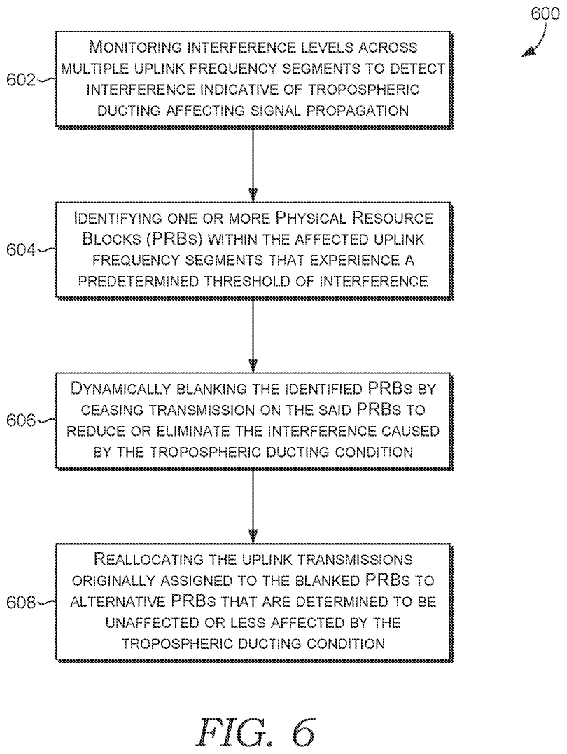

FIG. 6 illustrates a flow diagram of a method for proactively mitigating tropospheric ducting, in line with the described aspects. The method 600 commences at block 602, where the network management system monitors interference levels across multiple uplink frequency segments. By continuously analyzing the uplink frequency segments, the system can quickly identify any irregularities or spikes in interference levels that diverge from the norm. Moving to block 604, once an anomaly in interference levels is detected, the system identifies one or more PRBs within the affected uplink frequency segments that experience interference exceeding a predetermined threshold. At block 606, the method involves dynamically blanking the identified PRBs. This action, orchestrated by the network management system, involves ceasing transmission on these PRBs, effectively silencing them to reduce or eliminate the interference. Finally, step 608 details the reallocation of uplink transmissions. Transmissions originally assigned to the now-blanked PRBs are moved to alternative PRBs, which have been determined to be unaffected or less impacted by the tropospheric ducting condition. This strategic reallocation allows for continuous network connectivity and service provision, ensuring that user experience remains unaffected by the underlying atmospheric conditions.

In the process of reallocating uplink transmissions, the system can prioritize critical communication services and emergency calls. This ensures the continuity of essential services, particularly in scenarios where network capacity may be compromised due to tropospheric ducting. The dynamic blanking and reallocation of PRBs are further enhanced through the execution of a SON algorithm. This algorithm facilitates real-time adjustments in the network, enabling swift and efficient blanking and reallocation of PRBs to optimize network performance under the influence of tropospheric ducting In addition to these steps, the network management system is configured to generate and dispatch notification alerts to network operators. These alerts provide detailed information about the extent and specific location of uplink interference caused by tropospheric ducting, enabling prompt and informed responses from network maintenance teams.

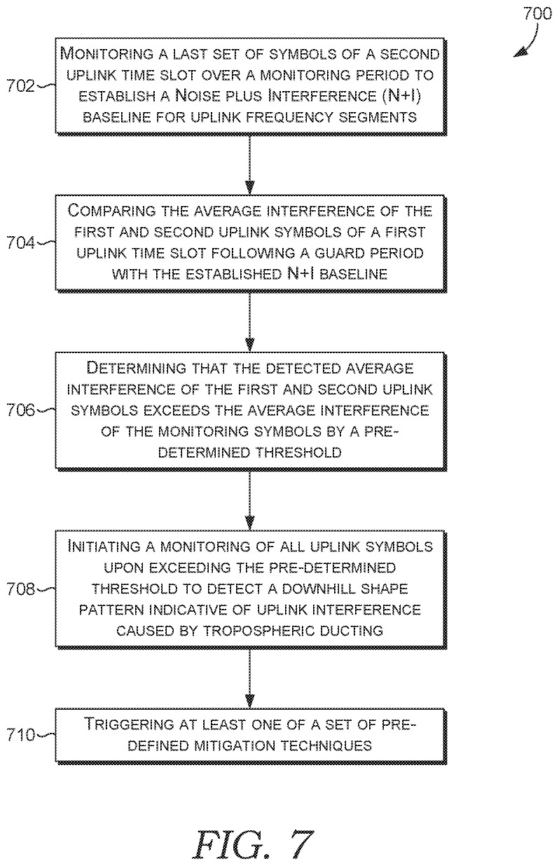

FIG. 7 illustrates a flow diagram of a method for proactively mitigating tropospheric ducting, in line with the described aspects. The method 700 commences at block 702, where the system engages in monitoring a set of symbols at the end of a second uplink time slot. This step is conducted over a defined monitoring period and is instrumental in establishing a Noise plus Interference (N+I) baseline across uplink frequency segments. The establishment of this baseline is essential for the system to discern between standard operational noise and interference levels that would signify anomalies necessitating further investigation. Progressing to block 704, the system compares the average interference of the first and second uplink symbols of a first uplink time slot—immediately following a guard period—with the established N+I baseline. Upon identifying any discrepancies, block 706 involves determining whether the detected average interference of these initial uplink symbols exceeds the established average interference of the monitoring symbols by a predefined threshold. Exceeding this threshold would suggest that the interference is not merely a product of usual network fluctuations but may instead be a result of a more disruptive influence, such as tropospheric ducting.

When the interference surpasses the predetermined threshold, the protocol advances to block 708, which triggers a comprehensive monitoring of all uplink symbols. This intensive monitoring is aimed at detecting a specific pattern, namely, a downhill shape in the signal's quality over time. The presence of this pattern is indicative of uplink interference that is consistent with the effects of tropospheric ducting, which can cause a progressive deterioration in signal quality. If such a downhill trend is observed, the system moves to block 710, which calls for the triggering of one or more predefined mitigation techniques. Furthermore, the system integrates the execution of a Self-Organizing Network (SON) algorithm. This algorithm automatically adjusts various operational parameters of the victim base station, such as power levels and antenna configurations, in direct response to the detected average interference. The SON algorithm enhances the base station's ability to adapt to the changing interference landscape dynamically.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A non-transitory computer readable media having instructions stored thereon that, when executed by one or more computer processing components, cause the one or more computer processing components to perform a method for mitigating atmospheric ducting occurring within a telecommunications network, the method comprising:
detecting, by a network management system, a condition of tropospheric ducting affecting signal propagation within a predefined frequency band of the telecommunications network;
identifying, by the network management system, one or more affected segments within the predefined frequency band where a Random Access Channel (RACH) is operational; and
dynamically reallocating, by the network management system, the RACH from the one or more affected segments to one or more alternate segments within the predefined frequency band that are determined to be less affected by the condition of tropospheric ducting based on real-time network data.

2. The non-transitory computer readable media of claim 1, wherein detecting the condition of tropospheric ducting includes monitoring a last set of symbols of a second uplink time slot over a monitoring period to establish a Noise plus Interference (N+I) baseline for uplink frequency segments.

3. The non-transitory computer readable media of claim 2, wherein identifying one or more affected segments further comprises comparing an average interference of a first uplink symbol and a second uplink symbol of a first uplink time slot following a guard period with the established N+I baseline.

4. The non-transitory computer readable media of claim 3, further comprising determining that the average interference of the first uplink symbol and the second uplink symbol exceeds the average interference of the last set of symbols by a pre-determined threshold.

5. The non-transitory computer readable media of claim 4, wherein upon determining that the average interference exceeds the predetermined threshold, the method includes initiating a monitoring of all uplink symbols to detect a downhill shape pattern indicative of uplink interference caused by tropospheric ducting.

6. The non-transitory computer readable media of claim 5, wherein the method further comprises triggering at least one of a set of pre-defined mitigation techniques upon detection of the downhill shape pattern.

7. The non-transitory computer readable media of claim 6, wherein the set of pre-defined mitigation techniques includes transmitting 3GPP Remote Interference Management Reference Signals (RIM-RS) across one or more affected uplink symbols.

8. The non-transitory computer readable media of claim 6, wherein the set of pre-defined mitigation techniques includes dynamically blanking identified Physical Resource Blocks (PRBs) by ceasing transmission on the said PRBs to reduce or eliminate interference.

9. The non-transitory computer readable media of claim 8, wherein the set of pre-defined mitigation techniques includes reallocating uplink transmissions originally assigned to the blanked PRBs to alternative PRBs within the predefined frequency band.

10. A system for enhanced provision of notifications in a wireless telecommunication network, the system comprising:
a victim base station configured to wirelessly communicate with a user equipment (UE); and
one or more computer processing components configured to perform operations comprising:
monitoring a last set of symbols of a second uplink time slot over a monitoring period to establish a Noise plus Interference (N+I) baseline for uplink frequency segments;
comparing an average interference of a first uplink symbol and a second uplink symbol of a first uplink time slot following a guard period with the established N+I baseline;
determining that the average interference of the first uplink symbol and the second uplink symbol exceeds the average interference of the last set of symbols by a pre-determined threshold;
initiating a monitoring of all uplink symbols upon exceeding the pre-determined threshold to detect a downhill shape pattern indicative of uplink interference caused by tropospheric ducting;
triggering at least one of a set of pre-defined mitigation techniques.

11. The system of claim 10, wherein the triggering of at least one of the set of pre-defined mitigation techniques includes dynamically blanking Physical Resource Blocks (PRBs) that are experiencing interference above the pre-determined threshold.

12. The system of claim 10, wherein the set of pre-defined mitigation techniques includes reallocating uplink transmissions from the blanked PRBs to alternative PRBs determined to be unaffected by the tropospheric ducting.

13. The system of claim 10, wherein the set of pre-defined mitigation techniques includes dynamic random access channel (RACH) allocation within the victim base station.

14. The system of claim 10, wherein the one or more computer processing components are further configured to generate and send notification alerts to network operators detailing an extent and specific location of an uplink interference caused by the tropospheric ducting.

15. The system of claim 10, wherein the one or more computer processing components are further configured to execute a Self-Organizing Network (SON) algorithm to automatically adjust one or more operational parameters of the victim base station in response to the average interference.

16. A method for mitigating tropospheric ducting in a wireless telecommunication network, the method comprising:
monitoring interference levels across multiple uplink symbols to detect interference indicative of tropospheric ducting affecting signal propagation;
identifying one or more physical resource blocks (PRBs) within the multiple uplink symbols that exceed a predetermined threshold of interference;
dynamically blanking the identified PRBs by ceasing transmission on the said PRBs to reduce or eliminate the interference caused by the tropospheric ducting; and
reallocating one or more uplink transmissions originally assigned to the blanked PRBs to alternative PRBs that are determined to be unaffected or less affected by the tropospheric ducting.

17. The method of claim 16, wherein identifying the PRBs experiencing interference includes analyzing a signal strength, a signal quality, and one or more noise measurements over a set monitoring period.

18. The method of claim 16, further comprising executing a Self-Organizing Network (SON) algorithm to facilitate the blanking and reallocation of PRBs in real-time.

19. The method of claim 16, wherein the reallocation of uplink transmissions includes prioritizing critical communication services and emergency calls to ensure their continuity.

20. The method of claim 16, wherein the monitoring interference levels across the multiple uplink symbols to detect interference comprises identifying a downward trend in the multiple uplink symbols.
